(19) United States
(12) Patent Application Publication
(10) Pub. No.: US 2018/0207867 A1
(43) Pub. Date: Jul. 26, 2018

(54) METHOD AND APPARATUS FOR PHOTO-CURING PHOTO-SENSITIVE MATERIALS FOR THE FORMATION OF THREE-DIMENSIONAL OBJECTS IN A TANK WITH A FLEXIBLE, SELF-LUBRICATING SUBSTRATUM

(71) Applicant: NEXA3D INC., Ventura, CA (US)

(72) Inventors: Izhar Medalsy, Ventura, CA (US); Luciano Tringaly, Rome (IT)

(21) Appl. No.: 15/925,140

(22) Filed: Mar. 19, 2018

Related U.S. Application Data
(63) Continuation-in-part of application No. PCT/IT2016/000225, filed on Oct. 3, 2016.
Application No. PCT/IT2016/000225 is a continuation-in-part of application No. 15/415,688, filed on Jan. 25, 2017.
Application No. 15/415,688 is a continuation-in-part of application No. PCT/IT2016/000225, filed on Oct. 3, 2016.

(30) Foreign Application Priority Data
Oct. 2, 2015 (IT) 102015000057527

(51) Int. Cl. B29C 64/188; B29C 64/135; B29C 64/25; B29C 64/245; B29C 64/264; B29C 64/30; B33Y 10/00; B33Y 30/00; B33Y 40/00; B33Y 70/00

(52) U.S. Cl. CPC B29C 64/188; B29C 64/135; B29C 64/25; B29C 64/245; B29C 64/264; B29K 2105/24; B33Y 10/00; B33Y 30/00; B33Y 40/00; B33Y 70/00; B29C 64/30

(57) ABSTRACT

Methods and apparatus for forming three-dimensional objects by photo-curing a photo-curing liquid polymer exposed to a radiation. The three-dimensional objects form by growth, due to the progressive curing of the photo-curing liquid polymer within the tank, in the space between a transparent base and a supporting plate. On the side of the transparent base facing towards the photo-curing liquid polymer, a membrane is arranged, said membrane being transparent to said radiation and being covered by a layer of liquid lubricant, which is released gradually by said membrane. The membrane is flexible, allowing it to bend or arch during formation of the three-dimensional objects when the supporting plate is raised.

### RELATED APPLICATIONS

This is a CONTINUATION-IN-PART of International Application No. PCT/IT2016/000225, filed Oct. 3, 2016, which claims priority to IT102015000057527, filed Oct. 2, 2015; and is also a CONTINUATION-IN-PART of U.S. application Ser. No. 15/415,688, filed Jan. 25, 2017, which is a CONTINUATION-IN-PART of International Application No. PCT/IT2016/000225, filed Oct. 3, 2016, which claims priority to IT102015000057527, filed Oct. 2, 2015, each of which is incorporated herein by reference in its respective entirety.

### FIELD OF THE INVENTION

The present invention relates to the field of three-dimensional printing, commonly referred to as 3D printing, and in particular to 3D printing by means of photo-curing photo-sensitive materials for the formation of three-dimensional objects in a tank with a flexible, self-lubricating substratum.

### BACKGROUND

As described in the above-cited patent applications, within the field of 3D printing technology the formation of three-dimensional objects through photo-curing of photo-sensitive materials comprises two basic technologies: stereolithographic (“SLA”) printing, in which a laser emitting around 400 nm is used to solidify, by means of the beam emitted, a liquid, photo-curing polymer which is in a special tank; and digital light processing (“DLP”) printing, according to which a photo-curing polymer, again in a liquid state in a tank, is exposed to luminous radiation emitted by a device similar to a projector. According to both these technologies, the printing process proceeds in a bottom-up style by making one layer after another; that is, solidifying a first layer adhering to a supporting plate (or extraction plate), and then a second layer adhering to the first layer, and so on, until formation of the entire object is complete. Therefore, according to this technology, the data representing the three-dimensional object to be formed is organised as a series two-dimensional layers which represent transversal sections of the object.

As each layer of the object under construction is printed, the extraction plate is raised in a tilting movement. Generally, such extraction plates consist of a material which facilitates the gluing on itself of the first layer of photo-cured polymer. In brief, the extraction plate moves to a predetermined distance from where the first layer of the object will be formed in the tank of photo-sensitive material (the so-called “resin”), and waits for the light beam (SLA or DLP) to solidify the first layer. It then raises by a distance sufficient for the layer just formed to detach from the base of the tank (usually approx. 1 mm) and then lowers by the same distance, less the predetermined distance for the formation of the second layer. This process continues until the entire object is formed. The resulting to and fro movement, known as the tilting movement, has two main purposes: it allows the layer just formed to detach from the base of the tank, and at the same time it allows a new quantity of liquid resin not polymerised to interpose between the layer just formed and the base of the container, thus refreshing material still in the liquid state beneath the layer already solidified for the curing and formation of the next layer. The tilting movement has an associated time, which must take into account the time for the extraction plate to rise and lower and for the renewal or refreshing of the very viscous resin in the printing region.

Another issue of importance in SLA and DLP printing is the makeup of the resin collection system, the so-called tank, in which the liquid polymer from which the printed three-dimensional object is obtained by photo-curing is collected. In order to avoid tearing the newly-formed layer of polymer from other portions of the three-dimensional object under construction when the extraction plate is raised, the tank must permit detachment of that just-formed layer from its surface (typically, a transparent base that allows the passage of ultra-violet (UV) light for triggering the photo-curing process, e.g., quartz or borosilicate glass). Often, a non-stick coating is applied to the inside surface of the tank to allow the first layer of cured polymer to adhere to the extraction plate and successive layers to join together in sequence.

However, in conventional 3D SLA and DLP printers there exists a suction effect, which occurs between the surface of the object under construction and the non-stick material which covers the transparent base of the tank, and which imposes limiting effects on the speed with which the object can be printed. In effect, a newly-formed polymer layer remains immersed in the resin at a distance “s” (equal to the thickness of the next layer of the object being formed) from the non-stick surface of the tank (both surfaces being coplanar and flat to give precision to the layer which will be formed); and a new layer is generated by photo-curing. The absence of air creates a vacuum between the two surfaces, which are surrounded by a liquid with a high viscosity, and the two surfaces in contact are as large as possible; thus, the mechanical stress suffered by the system and, consequently, by the new layer being formed (which is only a few tenths of a millimetre thick) is significant, with an attendant risk of tearing the layer which has just been formed if the previous layer is displaced vertically in a rapid fashion.

In order to reduce this risk of tearing, the printing process proceeds in such a way that the surface of the extraction plate and of the objects to be created are sufficiently small (usually on the order of 4×4-5×5 centimetres), and the raising speed of the extraction plate during the tilting step is slow. This means that production of the three-dimensional object proceeds very slowly, often on the order of hours per centimeter.

### SUMMARY OF THE INVENTION

The present invention provides methods and apparatus for forming three-dimensional objects by photo-curing a photo-curing liquid polymer exposed to a radiation, wherein said three-dimensional objects form by growth, due to the progressive curing of said photo-curing liquid polymer, in a space between a base transparent to the radiation and a supporting plate, said supporting plate progressively moving away from said transparent base, said methods and apparatus being characterized in that on a side of said transparent base facing towards said photo-curing liquid polymer a flexible membrane is disposed on or above said transparent base, said membrane being transparent to said radiation and covered by a layer of liquid lubricant, which is released gradually by said membrane.

### BRIEF DESCRIPTION OF THE DRAWINGS

The present invention is described, by way of example and without limiting the scope of the invention, with reference to the accompanying drawings which illustrate preferred embodiments of it, in which:

FIGS. 1A and 1B show a cutaway perspective view and a cross-sectional view, respectively, of a tank for an apparatus for forming an object by means of photo-curing, in which a self-lubricating membrane is displaced on or above a base of the tank according to an embodiment of the invention,

FIG. 2 shows a schematic view of a self-lubricating membrane for use in an apparatus for forming an object by means of photo-curing according to a first embodiment of the invention,

FIG. 3 shows a schematic view of the self-lubricating membrane for use in an apparatus for forming an object by means of photo-curing according to a further embodiment of the invention,

FIG. 4 shows a schematic view of a system for forming objects by photo-curing in which a self-lubricating membrane is displaced from a transparent base of the tank according to an embodiment of the invention, and

FIGS. 5A-5D show the flexing of a self-lubricating membrane during a printing process according to an embodiment of the invention.

### DETAILED DESCRIPTION

In the above-cited patent applications, methods and apparatus for photo-curing of three-dimensional objects from photo-sensitive materials using a tank with a self-lubricating substratum are described. These methods and apparatus propose to eliminate the suction effect resulting from a vacuum between the surface of the object being formed and a non-stick material positioned beneath it, eliminate adherences between the layer being formed and the tank base, and reduce mechanical stresses introduced by the above-mentioned effects, thereby allowing the printing process to proceed much more quickly than is possible with conventional SLA and DLP printers. In particular, such methods and apparatus for photo-curing of three-dimensional objects from photo-sensitive materials involve interposing, between the base of the tank and the photo-curing liquid polymer, a membrane that is transparent to the electromagnetic spectrum of interest for the photo-curing process, and which is able to gradually release a layer of lubricating material, thereby allowing the photo-curing liquid polymer to solidify while remaining suspended on the layer of the lubricating material.

In accordance with embodiments of the present invention, the membrane is flexible and, optionally, may be displaced vertically some distance (e.g., a few microns to a few millimetres) from the base of the tank (which may be a transparent plate of quartz or borosilicate glass). Preferably, the flexible membrane is positioned on the base of the tank, but where it is displaced above the base, an air gap is introduced between the base of the tank and a bottom surface of the membrane. This air gap may be pressurized, if the space between the membrane and the base of the tank is sealed around its edges, or may be left open (i.e., at atmospheric pressure). The properties of the membrane allow it to flex as the extraction plate is displaced vertically during the printing process. As a result, the thin layer of the object under construction that has just been formed does not experience shear and/or peeling forces as great as it otherwise would if the membrane remained flat (adhering to the base of the tank). Where present, an air gap between the membrane and the base of the tank may provide for cooling during printing, for example if a cooling fluid or gas is circulated therein.

More specifically, as the extraction plate is raised during the printing process, so too is the newly-formed layer of the object under construction. This is because that newly-formed layer adheres to the preceding layers of the object as the liquid polymer cures. The polymer resin is very viscous, and there is an absence of air (i.e., a vacuum or partial vacuum) between the newly-formed layer of the object under construction and the membrane. Consequently, as that newly-formed layer rises (as a result of the raising of the extraction plate), the membrane is drawn upwards (i.e., flexes) in an area immediately beneath the newly-formed layer. The flexing is made possible by the properties of the membrane and, in some instances, may be aided by the existence of an air gap between the membrane and the base of the tank. As the extraction plate and the newly-formed layer continue to rise, the membrane gradually peels away from the newly-formed layer of the object due to its elastic nature. This gradual separation of the membrane and the newly-formed layer of the object further reduces mechanical stresses on the newly-formed polymer layer, thereby further reducing the risk of that layer tearing away from the previously-formed portions of the object under construction. Experiments have shown that because of this reducing of the mechanical stresses, the overall printing process can proceed at a faster rate than would be the case of the membrane were in contact with the base of the tank; that is, less time is lost to the process of repositioning the extraction plate between printing of layers because there is less stress placed on the newly-formed layer during that process and, hence, the extraction plate can be repositioned at greater speed than would otherwise be the case.

As indicated above, the membrane flexes because it is made of a material having beneficial elastic properties. After flexing, the membrane will return to its previous planar orientation in accordance with its elastic properties, but by then the newly-formed polymer layer will have adhered sufficiently to the previous layers of the object under construction so that the relaxing of the membrane will not result in tearing of the layers of the object. By allowing the membrane to flex in this fashion, the overall printing speeds are increased because the extraction plate can be repositioned more quickly than would otherwise be the case.

A first embodiment of the present invention therefore relates to a method for forming three-dimensional objects by photo-curing a photo-curing liquid polymer exposed to a radiation, wherein said three-dimensional objects form by growth, due to the progressive curing of said photo-curing liquid polymer, in a space between a base transparent to the radiation and a supporting plate, that is, a portion already formed of said objects, said supporting plate progressively moving away from said transparent base, characterized in that on a side of said transparent base facing towards said photo-curing liquid polymer a flexible membrane is disposed above said transparent base, said membrane being transparent to said radiation and covered by a layer of liquid lubricant, which is released gradually by said membrane. In some embodiments, the photo-curing liquid polymer may also contain, in part, the liquid lubricant. Optionally, an air gap may be present between said flexible membrane and the transparent base of the tank.

A second embodiment of this invention relates to an apparatus for forming three-dimensional objects by photo-curing a photo-curing liquid polymer through exposure to a radiation, said apparatus being of the type including a tank for collecting said photo-curing liquid polymer, the base of the tank having a hole covered by a material transparent to said radiation, and a supporting plate designed to move away from the base of the tank, said apparatus characterized in that, on the side of said base facing towards said photo-curing liquid polymer, a flexible membrane transparent to said radiation and being covered by a layer of liquid lubricant, which is released gradually by said membrane is disposed. Optionally, the flexible membrane may be displaced above the transparent material and separated therefrom by an air gap.

In one embodiment according to the invention, the flexible membrane is made with a clear, self-lubricating polymer, i.e., a polymer inside of which there is a liquid lubricant, preferably silicone, and the liquid lubricant is silicone oil, with a viscosity of between 50 and 1000 mm²/s (defined according to the centistoke model cSt at 23° C.), preferably between 300 and 400 mm²/s. In some instances, polytetrafluoroethylene (PTFE) may be present inside the membrane. The membrane is preferably molded to have few or no surface defects, no air bubbles, and a uniform (or nearly so) thickness of approximately 1.0 mm. The membrane preferably is heat resistant (in dry air) to +220° C. continuous and +260° C. intermittent, and remains flexible at temperatures down to approximately −40° C. The membrane preferably has a hardness between 40-90 (+/−5) Shore A, and has a modulus of elasticity between 0.001 and 0.05 GPa.

According to the present invention, the insertion of a layer of lubricating oil released by the membrane gradually over time and the flexible nature of the membrane allow the two characteristic problems of traditional bottom-up 3D printing systems to be resolved: the detachment of a layer just formed from the tank base and the refreshing of liquid polymer between the layer just formed and the tank base. The liquid polymer, suitably doped with ultraviolet catalysts and, optionally, lubricating substances, remains suspended on the oily lubricant layer as it hardens, not making contact with the base of the tank. Hence, there is no need to effect detaching of the layer which has just been formed by raising the extraction plate in a tilting motion. Further, the extraction plate can be raised more quickly than would otherwise be the case because the flexible nature of the membrane allows for a reduction of mechanical stresses on the still-curing layer during the raising of the extraction plate. With regard to refreshing the liquid polymer, as the flexible membrane returns to its original planar orientation, polymer resin is drawn into the area from which the membrane retreats; thus providing rapid refreshing of the liquid polymer and alleviating the need for interrupting the extraction process whilst awaiting a refresh.

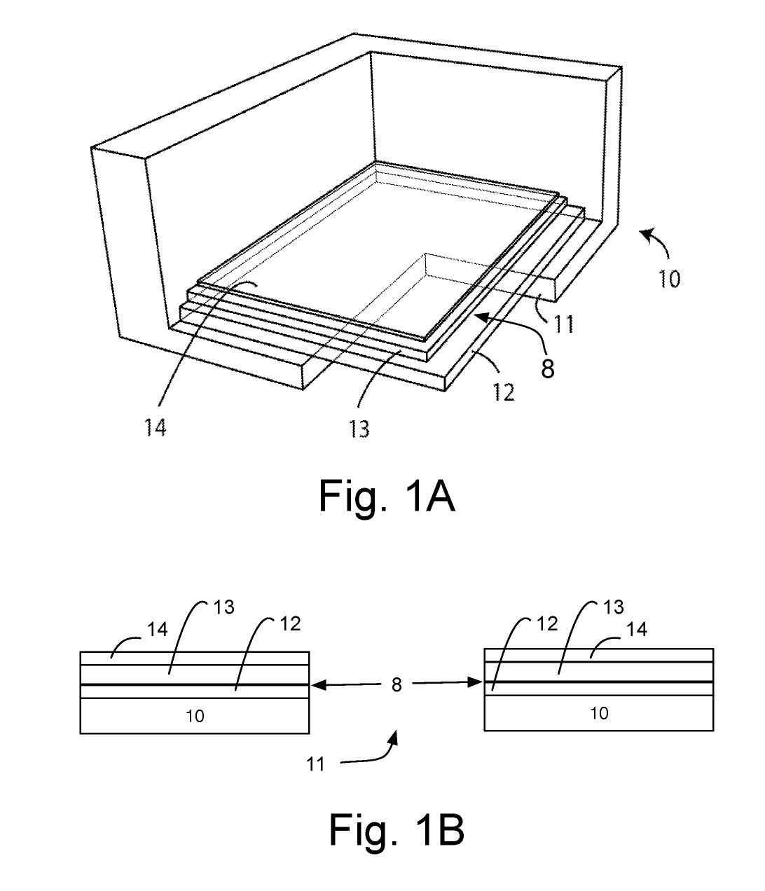

With reference to FIGS. 1A and 1B, the collection tank of the apparatus for photo-curing with self-lubricating substratum for the formation of three-dimensional objects according to this invention, denoted in its entirety with numeral 10, has in a central position a hole 11, which allows the passage of the incident luminous flow coming from a light source (not shown) located beneath the tank 10. The hole 11 is covered by a sheet 12, which may be made of borosilicate glass or quartz, or in any case of a material transparent to the UV spectrum, and more specifically, in the systems which use a digital projector of the DLP type for commercial use, transparent to a tail of the electromagnetic spectrum of the visible towards the ultraviolet band. The sheet 12, positioned on the base of the tank 10, prevents any escape of the liquid polymer contained in the tank.

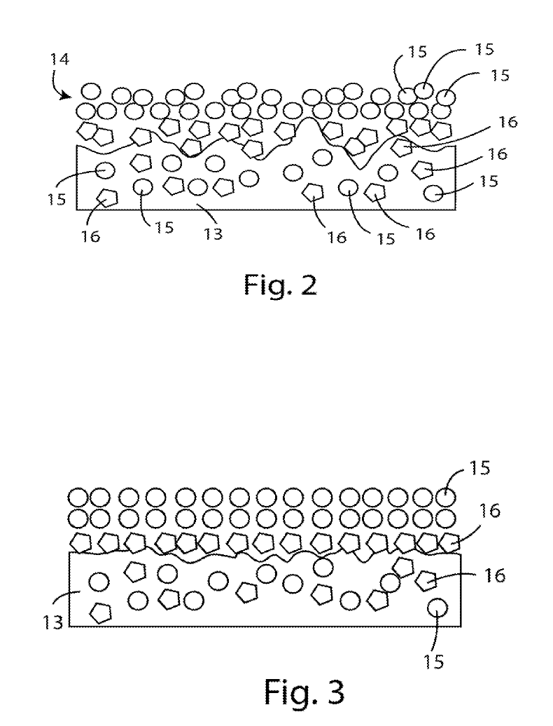

Above the sheet 12, and optional displaced a distance therefrom by an air gap 8 (e.g., in various embodiments, an air gap of a few micrometers to a few millimeters, for example 20 μm to 2 mm), there is a flexible membrane 13, made of a self-lubricating, silicone-based polymer with a low friction coefficient and a high resistance to wear, made using a mold and specific doping, which is able to release (as shown in FIG. 2) a layer of silicone and non-stick material, labelled 14, which in the system performs the role of buffer between the membrane 13 and the photo-curing polymer, the purpose of which is to assist in preventing the suction effect and the mechanical adherence characteristic of conventional bottom-up 3D printing systems, and for that reason is identified as inhibiting layer 14. Membrane 13 may have the properties and characteristics discussed above.

More specifically, and without limiting the scope of the invention, membrane 13 may be made of silicone-based polymers with the following characteristics: thickness between 0.50 mm and 2.50 mm, Shore hardness between 55 and 70 Shore A, failure load from 8 to 10 MPa, percentage elongation at failure from 300 to 400, and modulus of elasticity between 0.001 and 0.05 GPa. The best results (in terms of duration of the membrane) have been obtained with 70 Shore A hardness, but, as discussed above, membranes can be used with a wide range of hardness. However, it should be noted that it is also possible to use other types of materials with transparency characteristics, elasticity, and release of lubricants similar to those discussed herein.

Again with reference to FIG. 2, the silicone oil (dissolved inside the membrane 13 in the form of pellets denoted with numeral 15) is a lubricant which, when it is present in the self-lubricating polymer with which the membrane 13 is made, migrates from the inside of the material towards the outside, until reaching the surface, even during the use of the membrane 13, thereby contributing to the reduction of the friction and generating an inhibiting substratum 14 above which the polymer, still in the liquid state, remains suspended. In one embodiment, by way of example and without limiting the scope of the invention, the lubricant contained in the membrane 13 consists of a silicone oil with a viscosity of 350 mm²/s (defined according to the centistoke model cSt at 23° C.). However, it is possible to use silicone oils with various viscosities, in a range of between 50 and 1000 mm²/s. Also, the silicone oil may have polytetrafluoroethylene (PTFE) additives (labelled 16 in FIG. 2). Again by way of an example, it is possible to use as a lubricant, fluid resins of the type used for releasing moulds: for example, resin 9515 from Siliconi Padova used as a mould-release, as well as silicone oils of the Rhodorsil Huile 47 V 50 type also supplied by Siliconi Padova, produced by BlueStar Silicones.

The inventors have found that the need to maintain the lubricating layer for substantially the entire duration of the printing process has resulted in a preference for the use of silicone oils with a higher viscosity. Such oils more easily form a persistent layer on the entire interdiction surface than those with lower viscosities. Nevertheless, it is possible, as mentioned above, to use oils with viscosity characteristics distributed over a wide range: from 50 to 1000 mm²/s (defined according to the centistoke model cSt at 23° C.), with the best results in the range 300-400 mm²/s. PTFE can be added to the oils and other lubricating products can be used such as resins for releasing moulds such as, for example, resin 9515 by Siliconi Padova.

The advantages of the silicone-based additives are represented by the reduction of the friction coefficient and the wear factor. Further, excellent synergic effects are available if the silicone is coupled with the PTFE additives (labelled 16 in FIG. 2), which tend to migrate towards the outside of the membrane 13 before the silicone oil 15, creating a substratum which reduces the roughness of the membrane 13 and increases considerably its duration.

With regard to the choice of photo-curing polymers, according to this invention it is possible to use the resins already in use in the 3D printing sector, preferably with the addition of lubricant of the same type as that contained in the membrane 13. This enables the mechanical suction effect and the dilution of the lubricant contained in the membrane 13 by the liquid polymer to be reduced. The best results are obtained with percentages of lubricant dissolved in the photo-curing liquid polymer of 4-6%, but quantities of lubricant can be used which vary within a wide range according to the solubility and the desired characteristics of the solidified material. In effect, the greater the quantity of lubricant the more the solidified surface is opaque and with a satin finish. Moreover, with regard to the possible presence of PTFE 16 in the membrane 13 in addition to the lubricant 15, it has been seen that the presence of PTFE in the lubricant improves the lubrication characteristics, reduces the friction and improves the duration of the membrane 13 reducing the wear, but it is not essential. The phenomena described also occur with lubricants only based on silicone oils or with lubricating resins for mould release.

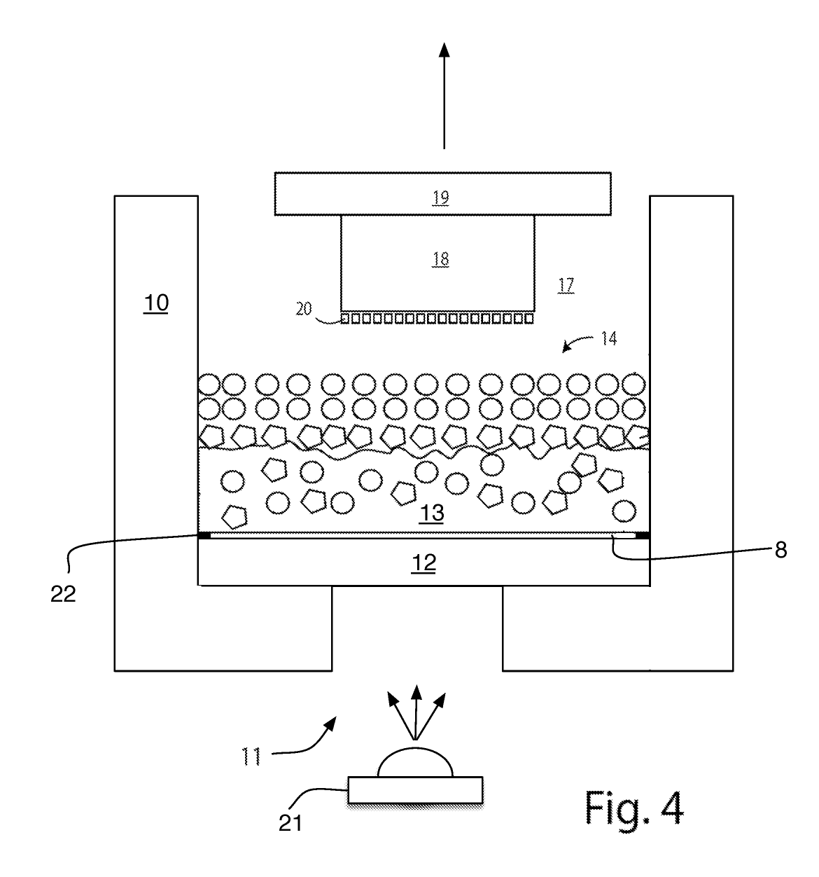

As discussed in the above-cited patent applications, it has been observed that, during the formation of the 3D object, the lubricating material which covers the membrane 13 tends to be removed; this reduction of the inhibiting layer 14 results in the contact of the resin (that is, the photo-curing liquid polymer) with the membrane 13, generating all the undesired effects known in the bottom-up systems. In order to limit this problem, the self-lubricating membrane 13 is preferably made according to a technique for injection of the basic polymer, in the liquid phase, suitably doped with silicone oil and PTFE, inside a hot steel mould, the faces of which have undergone a double mirror-finish and chromium-plating treatment, and waiting the time necessary for the solidification. With reference to FIG. 3, this intervention allows the surface roughness of the membrane 13 to be reduced (in addition to the presence of the PTFE particles), increasing considerably the duration of the printing. The surfaces of the mould must be treated with suitable mechanical finishing to obtain adequate surface roughness of the membrane. More specifically, the liquid polymer side surface must be particularly smooth. It is worthwhile subjecting the wall of the mould to be used for forming the surfaces to a chromium-plating and polishing treatment. This intervention enables the surface roughness of the membrane to be reduced and to increase the duration of the printing, before it deteriorates. Another possible intervention is that of post-working the membrane obtained by injection with a plasma treatment (used for the sterilisation of medical instruments) which has the purpose of intervening on the surface at a molecular level to close surface pores.

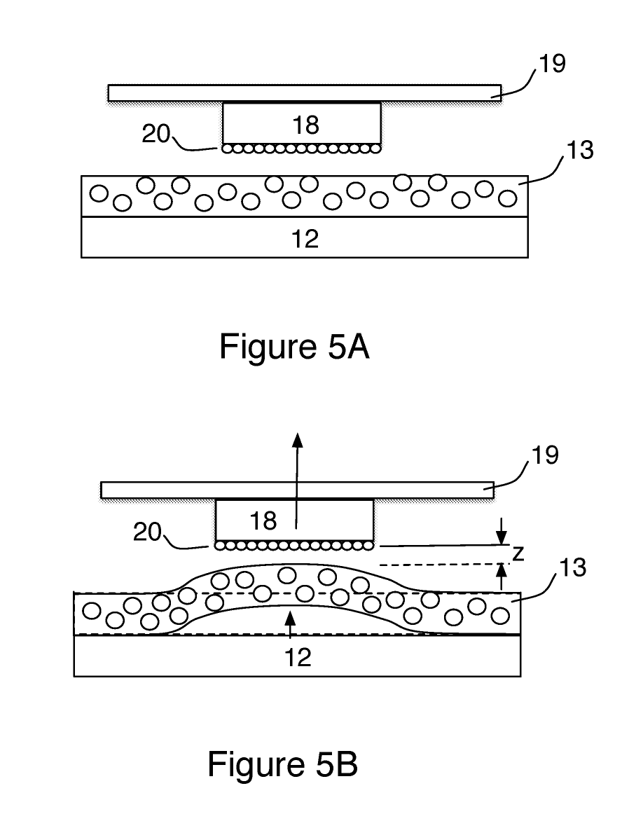

In preferred embodiments of the invention, the membrane 13 is allowed to rest on the base of the tank in which it is used. However, in accordance with optional embodiments of the present invention, the flexible membrane may be displaced vertically (that is, longitudinally along an axis defining a direction in which the extraction plate is moved during the printing process) some distance from the base of the tank, thereby introducing air gap 8 between the base of the tank 10 and a bottom surface of the membrane 13. Such an arrangement is illustrated in FIG. 4.

In this illustration, which is not to scale, within the tank 10, membrane 13, which made of a suitably doped and treated self-lubricating material, is supported at its perimeter adjacent the tank wall by a collar 22. Collar 22 may be made on any suitable material, including a polymer or a metal, and maintains an air gap 8 of a few micrometers to a few millimetres between the bottom of membrane 13 and the transparent base 12 at the bottom of the tank. Above the membrane 13, a slow migration of particles 15 of silicone oil, and more generally of lubricating material, creates a thin lubricating inhibiting layer 14. A contact interface is therefore generated between the resin 17, which is still liquid, and the membrane 13, in which the resin, instead of coming into contact with the surface of the membrane 13, tends to float on the interface. The photo-curing process, initiated by UV radiation from light source 21, therefore occurs suspended on the lubricating inhibiting layer 14 of silicone oil, which tends to reduce the suction effect between the object being formed 18 (of which a newly-formed layer 20 is shown in detail) and the membrane 13, reduce adherences between the object being formed 18 and the membrane 13, and reduce the mechanical stresses introduced by the above-mentioned effects, allowing formation of the object in much shorter times than the prior art solutions.

As discussed above, membrane 13 flexs when extraction plate 19 is raised during the printing process, thus allowing the formation of object 18 without the need for tilting. In effect, the object 18 does not need to be pulled from the membrane 13, because it is already suspended above it in the interface between the lubricating inhibiting layer 14 and resin/polymer 17. Furthermore, the flexing allows for gentle separation of the layer being formed, eliminating tearing of the layer being formed, which tearing can arise due to stresses created by the presence and viscosity of the resin 17 and the inhibiting layer 14. By flexing whilst the extraction plate 19 raises to make space for the new cured layer, membrane 13 provides not only for sequential printing, but also for continuous printing.

Where present, the air gap 8 may be pressurized provided the space between the membrane 13 and the base 12 of the tank 10 is sealed around its edges. If pressurized, which may help membrane 13 retain some rigidity, air or a noble gas may be used. Alternatively, air gap 8 may be left unsealed and may remain at atmospheric pressure. The presence of the air gap 8 allows the membrane 13 to flex as the extraction plate 19 is displaced vertically (i.e., in the direction shown in the illustration) during the printing process and may also facilitate cooling of the system.

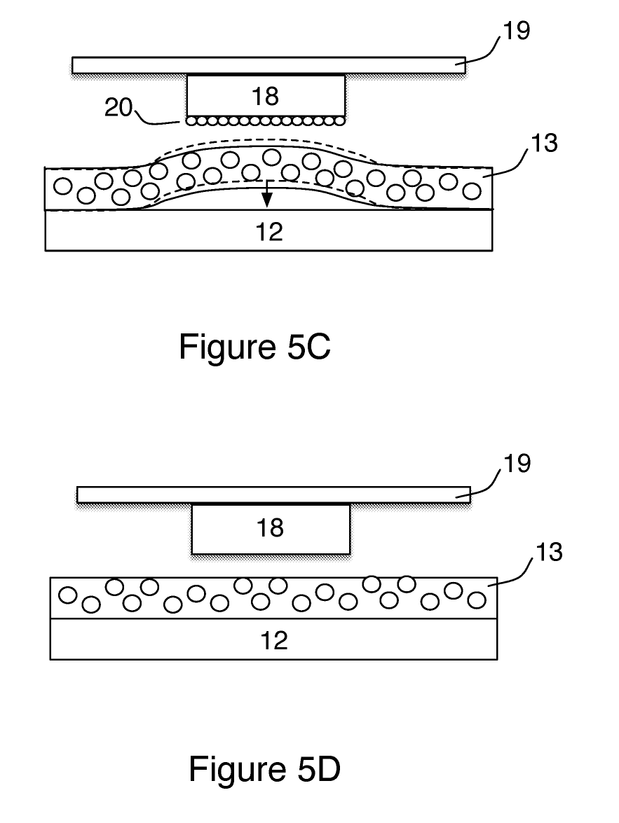

Whether or not the air gap is present, the flexing of membrane 13 while the extraction plate is raised means that the thin layer 20 of the object under construction that has just been formed does not experience shear and/or peeling forces as great as it otherwise would if the membrane remained flat (adhering to the base 12 of tank 10). More specifically, and as shown in FIGS. 5A-5D (in which no air gap is illustrated), as the extraction plate 19 is raised from an initial position (FIG. 5A) during the printing process, a position corresponding to layer 20 of object 18 being formed, to a new position (FIG. 5B) displaced vertically from the initial position b a distance “z” (typically a few microns to a few millimetres). That displacement causes the membrane 13 to flex upwardly (in the direction of the displacement of the extraction plate) in a region disposed beneath the newly formed layer 20. This is because the polymer resin and inhibiting layer in the region between layer 20 and membrane 13 is very viscous, and there is an absence of air (i.e., a vacuum) between newly-formed layer 20 and membrane 13. Consequently, there is a suction effect between the newly-formed layer 20 and membrane 13 such that, as the newly-formed layer 20 rises (as a result of the raising of the extraction plate 19), membrane 13 flexes upwards in an area immediately beneath newly-formed layer 20. The degree of flexing of membrane 13 depends on its composition, thickness, and modulus of elasticity.

As the extraction plate 19 and the newly-formed layer 20 continue to rise and then comes to rest at the next printing position (FIG. 5C), the membrane 13, as a consequence of its elastic nature, gradually returns to its original, planar orientation. This gradual rebound of the membrane 13 away the newly-formed layer 20 of the object 18 puts only limited mechanical stresses on the newly-formed polymer layer 20, thereby reducing the risk of that layer tearing away from the previously-formed portions of the object under construction. Once the membrane 13 has returned to its original position (FIG. 5D), printing of the next layer can commence. By this time, layer 20 has fully cured and is an integral part of object 18. Experiments have shown that because of the reduction of mechanical stresses on layer 20, the overall printing process can proceed at a faster rate than would be the case of the membrane 13 were not present. That is, less time is lost to the process of repositioning the extraction plate 19 between printing of successive layers because there is less stress placed on each newly-formed layer during that process.

Use of a flexible membrane in accordance with embodiments of the present invention also provides for replenishing photo-curing liquid polymer within an area of the tank in which photo-curing liquid polymer has been cured, thereby forming a new layer of the three-dimensional object under fabrication. For example, as a new layer is formed and the supporting plate on which the object is being fabricated is raised, the flexible membrane positioned below the object (or at least a portion of the membrane) is displaced above the base of the tank in the direction of motion of the supporting plate, as described above. Thereafter, due to its elastic nature, the membrane will return to an approximately planar orientation above the base of the tank, and in doing so will draw a volume of the photo-curing liquid polymer into the space between the flexible membrane and the object. The liquid polymer is very viscous. Therefore, the rate at which the liquid polymer will be drawn into the space between the flexible membrane and the object undergoing fabrication by virtue of the vacuum or partial vacuum created by the return to a planar orientation of the membrane is faster than that which would otherwise occur.

Thus, 3D printing by means of photo-curing photo-sensitive materials for the formation of three-dimensional objects in a tank with a flexible, self-lubricating substratum has been described.

What is claimed is:

1. A method for forming three-dimensional objects by photo-curing a photo-curing liquid polymer exposed to a radiation, wherein said three-dimensional objects form by growth, due to the progressive curing of said photo-curing liquid polymer, in a space between a tank base transparent to the radiation and a supporting plate, said supporting plate progressively moving away from said transparent base, characterized in that on a side of said transparent base facing towards said photo-curing liquid polymer a flexible membrane is disposed, said membrane being transparent to said radiation and covered by a layer of liquid lubricant, which is released gradually by said membrane, and said method includes said membrane displacing, at least partially in an area beneath said object, vertically in a direction towards said supporting plate in response to said supporting plate being raised from a first position to a second position, and said membrane then returning to an approximate planar orientation after said displacing.

2. The method of claim 1, further comprising, during said photo-curing of the photo-curing liquid polymer, pressurizing an air gap between said membrane and said transparent base.

3. An apparatus for forming three-dimensional objects by photo-curing a photo-curing liquid polymer through exposure to a radiation, said apparatus including a tank for collecting said photo-curing liquid polymer, a base of the tank having a hole therein covered by a material transparent to said radiation, and a supporting plate configured to move away from the base of the tank, characterized in that, on a side of said base facing towards said photo-curing liquid polymer, a flexible membrane is displaced above the transparent material, said membrane being transparent to said radiation, and being covered by a layer of liquid lubricant, which is released gradually by said membrane.

4. The apparatus of claim 3, wherein the transparent material comprises borosilicate glass or quartz.

5. The apparatus of claim 3, wherein said flexible membrane is displaced above the transparent material and separated therefrom by an air gap.

6. The apparatus of claim 5, wherein the air gap comprises an air gap of between 50 μm and 2 mm.

7. The apparatus of claim 3, wherein the membrane comprises a silicone-based polymer with a thickness between 0.50 mm and 2.50 mm.

8. The apparatus of claim 3, wherein the membrane comprises a silicone-based polymer with a hardness between 40-90 (+/−5) Shore A

9. The apparatus of claim 3, wherein the membrane comprises a silicone-based polymer with a hardness between 55-70 Shore A.

10. The apparatus of claim 3, wherein the membrane comprises a silicone-based polymer with a modulus of elasticity between 0.001 and 0.05 GPa.

11. The apparatus of claim 5, wherein the air gap is pressurized.

12. The apparatus of claim 5, wherein the air gap is open to atmosphere.

13. A method for replenishing photo-curing liquid polymer within an area of a tank of said photo-curing liquid polymer that has been cured due to exposure to a radiation, thereby forming a portion of a three-dimensional object under fabrication within said tank of said photo-curing liquid polymer, comprising subsequent to said formation of said portion, raising a supporting plate on which said object is being fabricated thereby causing a flexible membrane positioned between said object and a transparent base of said tank to flex in a direction of motion of the supporting plate before returning to an approximately planar orientation above said base of said tank, drawing a volume of said photo-curing liquid polymer into a space between said flexible membrane and said object.

14. The method of claim 13, further comprising, during said photo-curing of the photo-curing liquid polymer, pressurizing an air gap between said membrane and said transparent base.
